(19) United States
(12) Patent Application Publication
(10) Pub. No.: US 2025/0069448 A1
(43) Pub. Date: Feb. 27, 2025

(54) DRIVING PERFORMANCE VERIFICATION DEVICE AND DRIVING PERFORMANCE VERIFICATION METHOD OF AUTONOMOUS VEHICLE

(71) Applicant: CELLPLUSKOREA CO., LTD., Anyang-si (KR)

(72) Inventors: SANG MIN KIM, Seoul (KR); JUNG HUN SHIN, Goyang-si (KR); KYUNG JUN PARK, Suwon-si (KR); SUN HEUNG KIM, Yongin-si (KR)

(21) Appl. No.: 18/770,963

(22) Filed: Jul. 12, 2024

(30) Foreign Application Priority Data
Aug. 22, 2023 (KR) 10-2023-0109841

(51) Int. Cl. G07C 5/08; B60W 60/00; G06V 20/56

(52) U.S. Cl. CPC G07C 5/0808; B60W 60/0025; G06V 20/588; B60W 2556/10

(57) ABSTRACT

A driving performance verification device and driving performance verification method of an autonomous vehicle is proposed. The device includes a reception unit for operating in a driving mode and receiving sensing data sensed and provided in real time while driving is conducted on an actual road, a branch unit for operating in the driving mode, and branching and providing the sensing data into first sensing data and second sensing data, a sensing data regeneration unit for storing in real time the second sensing data and regenerating the stored second sensing data in a verification mode, and a verification control unit for providing the first sensing data to an ECU in the driving mode, obtaining first driving data, providing the second sensing data to the ECU in the verification mode, obtaining second driving data, and verifying driving performance by comparing the first driving data with the second driving data.

### CROSS REFERENCE TO RELATED APPLICATION

The present application claims priority to Korean Patent Application No. 10-2023-0109841, filed Aug. 22, 2023, the entire contents of which are incorporated herein for all purposes by this reference.

### BACKGROUND OF THE INVENTION

### Field of the Invention

The present disclosure relates to a driving performance verification device and driving performance verification method of an autonomous vehicle and, more particularly, to a driving performance verification device and driving performance verification method of an autonomous vehicle, wherein driving performance may be verified by performing actual vehicle simulation on the basis of sensing data sensed on an actual road.

### Description of the Related Art

An autonomous vehicle refers to a vehicle that moves to a destination by controlling the driving of the vehicle by itself, rather than having a driver performing driving of the vehicle. In order to operate the autonomous vehicle, various types of sensors are required to monitor the surrounding environment on behalf of the driver. The autonomous vehicle uses sensing data sensed by the sensors to accurately recognize objects such as people, animals, other vehicles, and traffic lights (hereinafter referred to as “object information”), and then performs corresponding driving control after the recognition.

Autonomous vehicles have the advantage of not only preventing accidents or aggressive driving caused by careless mistakes of drivers, but also enabling unlicensed, blind, and minors to freely use the vehicles, so much research has been conducted recently regarding autonomous driving control.

However, since road environments where vehicles actually drive are unpredictable in many areas and there are many variables that may occur as well, verification of the driving performance of autonomous vehicles is required in order to provide safe and accurate autonomous driving.

Conventional verification of driving performance has been performed by using simulators that set up various accident environments, and as the verification is performed by using the accident environments created within such simulators and corresponding algorithms thereof, there is a problem in that actual vehicle verification or verification using road data sensed on an actual road is not performed.

### DOCUMENTS OF RELATED ART

(Patent Document 1) Korea Patent Application Publication No. 10-2022-0097646 (published on Jul. 8, 2022).

### SUMMARY OF THE INVENTION

Therefore, an objective of the present disclosure is to provide a driving performance verification device and driving performance verification method of an autonomous vehicle, wherein the above-described conventional problem may be overcome.

Another objective of the present disclosure is to provide a driving performance verification device and driving performance verification method of an autonomous vehicle, wherein driving performance may be verified efficiently and effectively by performing actual vehicle simulation on the basis of sensing data sensed on an actual road.

According to an exemplary embodiment of the present invention to solve some of the above technical problems, there is provided a driving performance verification device for an autonomous vehicle according to the present disclosure, the device including: a reception unit configured to operate in a driving mode and receive in real time sensing data sensed and provided in real time from each of sensors mounted on the autonomous vehicle while driving is conducted on an actual road; a branch unit configured to operate in the driving mode, and branch and provide the sensing data into first sensing data and second sensing data, which are identical to each other; a sensing data regeneration unit configured to store in real time the second sensing data provided from the branch unit in the driving mode and regenerate the stored second sensing data in a verification mode; and a verification control unit configured to allow, in the driving mode performed on the actual road, the first sensing data provided in real time to be provided to an electronic control unit (ECU) of the autonomous vehicle and obtain first driving data by allowing the electronic control unit (ECU) to perform autonomous driving on the actual road in response to the first sensing data, and configured to control, in the verification mode performed on a separately set test road, the second sensing data regenerated through the sensing data regeneration unit to be provided to the electronic control unit (ECU), obtain second driving data by allowing the electronic control unit (ECU) to perform the autonomous driving on the test road in response to the second sensing data, and verify driving performance through match or not by comparing the first driving data recording a driving situation in the driving mode with the second driving data recording a driving situation in the verification mode.

In the verification mode, the reception unit and the branch unit may not operate.

The sensors may include at least one of a camera, a lidar, a radar, an ultrasonic sensor, a steering sensor, a temperature/humidity sensor, and a GPS.

The electronic control unit (ECU) may be provided with a learned AI autonomous driving algorithm built therein and performs the autonomous driving in response to the first sensing data or the second sensing data.

According to another exemplary embodiment of the present invention to solve some of the above technical problems, there is provided a driving performance verification method for an autonomous vehicle according to the present disclosure, the method including: a first step of starting a driving mode performed on an actual road and branching sensing data sensed and received in real time from each of sensors mounted on the autonomous vehicle while driving is conducted on the actual road into first sensing data and second sensing data, which are identical to each other; a second step of allowing the first sensing data to be provided to an electronic control unit (ECU) of the autonomous vehicle and storing the second sensing data; a third step of obtaining first driving data by allowing the electronic control unit (ECU) to perform autonomous driving on the actual road in response to the first sensing data; a fourth step of starting a verification mode performed on a separately set test road and regenerating the second sensing data so as to allow the second sensing data to be provided to the electronic control unit (ECU); a fifth step of obtaining second driving data by allowing the electronic control unit (ECU) to perform the autonomous driving on the test road in response to the second sensing data; and a sixth step of performing verification on driving performance through match or not by comparing the first driving data recording a driving situation in the driving mode with the second driving data recording a driving situation in the verification mode.

The sensors may include at least one of a camera, a lidar, a radar, an ultrasonic sensor, a steering sensor, a temperature/humidity sensor, and a GPS.

Each of the first driving data and the second driving data may include information on operation status of each part required for the driving of the autonomous vehicle.

According to the present: disclosure, the driving performance of an autonomous vehicle may be accurately and effectively verified by performing actual vehicle simulation on the basis of sensing data sensed on an actual road.

### BRIEF DESCRIPTION OF THE DRAWINGS

FIG. 1 is a schematic view of a driving performance verification device of an autonomous vehicle according to the present disclosure.

FIG. 2 is a block diagram illustrating an internal configuration of the driving performance verification device in FIG. 1.

FIG. 3 is a flowchart illustrating operation in a driving mode.

FIG. 4 is a flowchart illustrating operation in a verification mode.

### DETAILED DESCRIPTION OF THE INVENTION

Hereinafter, with no intention other than to provide a thorough understanding of the present disclosure to those skilled in the art to which the present disclosure pertains, a preferred exemplary embodiment of the present disclosure will be described in detail with reference to the accompanying drawings.

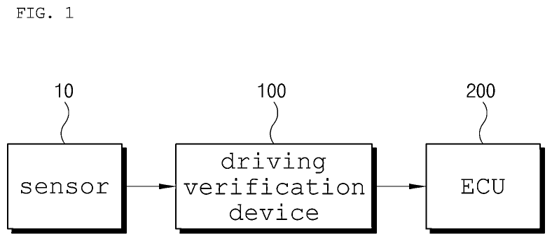

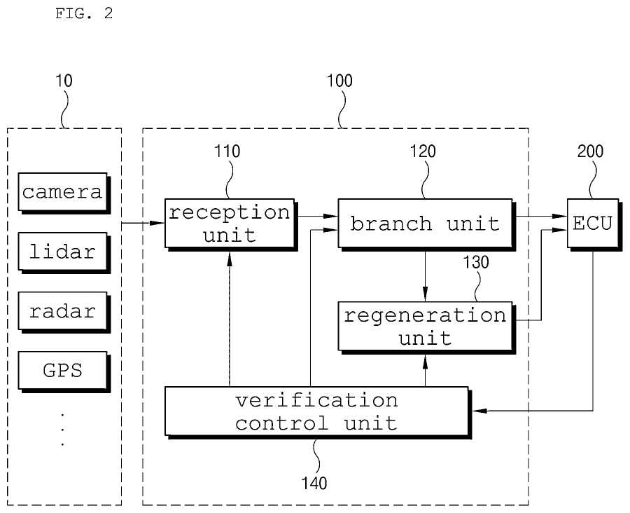

FIG. 1 is a schematic view of a driving performance verification device of an autonomous vehicle according to the present disclosure. FIG. 2 is a block diagram illustrating an internal configuration of the driving performance verification device in FIG. 1.

As shown in FIGS. 1 and 2, the driving performance verification device 100 of an autonomous vehicle according to the present disclosure is for verifying the performance of driving control of the autonomous vehicle, is mounted in between an electronic control unit (ECU) 200 and a sensor 10, which are mounted in the autonomous vehicle, and is configured to include a reception unit 110, a branch unit 120, a regeneration unit 130, and a verification control unit 140.

The driving performance verification device 100 of the autonomous vehicle according to the present disclosure is for verifying driving performance on the basis of sensing data obtained while driving is conducted on an actual road, and is configured to perform the verification divided by a driving mode and a verification mode. In the driving mode, the sensing data is obtained while the driving is conducted on the actual road, and in the verification mode, a test drive is performed on the basis of the sensing data obtained in the driving mode, so that driving data in the driving mode and driving data in the verification mode are compared with each other, thereby verifying the driving performance of the autonomous vehicle. Here, the reception unit 110 and the branch unit 120 operate only in the driving mode and do not operate in the verification mode, and the regeneration unit 130 and the verification control unit 140 operate in both the driving mode and the verification mode.

Here, the sensors 10 may include at least one of a camera, a lidar, a radar, an ultrasonic sensor, a steering sensor, a temperature/humidity sensor, and a GPS, and above this, may further include various types of sensors known to those skilled in the art as required for autonomous driving.

The electronic control unit (ECU) 200 is built into the autonomous vehicle to control the overall operation of the autonomous vehicle, and has a component provided with a learned AI autonomous driving algorithm built therein to perform the autonomous driving in response to the sensing data sensed by the sensors 10. The configuration and operation of the electronic control unit (ECU) are well known to those skilled in the art.

The reception unit 110 operates in the driving mode, receives the sensing data sensed and provided in real time from each sensor 10 mounted on the autonomous vehicle while the driving is conducted on the actual road, and provides the sensing data to the branch unit 120.

The branch unit 120 branches the sensing data received in real time through the reception unit 110 into first sensing data and second sensing data, which are identical to each other. The branch unit 120 may be provided with a module for branching data. Corresponding to the number of sensors, a plurality of branch units 120 may be provided independently.

That is, a branch unit may be provided on each sensor, such as to be a branch unit for a camera, a branch unit for a lidar, a branch unit for a radar, etc.

Here, under the control of the verification control unit 140, the first sensing data is provided to the electronic control unit (ECU) and the second sensing data is provided to the regeneration unit 130.

When the first sensing data is transmitted to the electronic control unit (ECU), the electronic control unit (ECU) analyzes the first sensing data by using the learned AI autonomous driving algorithm, recognize and determine object information such as obstacles, signals, lanes, etc., and performs autonomous driving on the actual road. In this case, while driving on the actual road, the autonomous vehicle performs the autonomous driving on the actual road in response to the first sensing data sensed in real time from each sensor 10.

The regeneration unit 130 stores the second sensing data provided in real time from the branch unit 120 in the driving mode, and regenerates the stored second sensing data to provide the second sensing data to the electronic control unit (ECU) in the verification mode. In the verification mode, the sensing data sensed in real time through each sensor 10 is not provided to the electronic control unit (ECU), but the second sensing data regenerated through the regeneration unit 130 is provided to the electronic control unit (ECU). The electronic control unit (ECU) analyzes the second sensing data by using the learned AI autonomous driving algorithm, determines obstacles, signals, lanes, etc., and performs the autonomous driving.

The verification control unit 140 controls the operation of the driving mode for performing the autonomous driving on the actual road through the first sensing data sensed and provided in real time through each sensor 10, and the operation of the verification mode for performing autonomous driving on a test road through the second sensing data regenerated through the regeneration unit 130.

Specifically, in the driving mode, the verification control unit 140 provides the first sensing data provided in real time to the electronic control unit (ECU) through the branch unit 120, thereby allowing the electronic control unit (ECU) to control the driving of the autonomous vehicle on the actual road in response to the first sensing data. In addition, in the verification mode, the verification control unit 140 allows the autonomous driving to be performed on a separately set test road, and provides the second sensing data regenerated and provided through the regeneration unit 130 to the electronic control unit (ECU), thereby allowing the electronic control unit (ECU) to control the test driving of the autonomous vehicle on the test road in response to the second sensing data.

Thereafter, the driving performance of the autonomous vehicle is verified through match or not by comparing the first driving data recording a driving situation in the driving mode with the second driving data recording a driving situation in the verification mode, the first and second driving data being provided from the electronic control unit (ECU).

In a conventional instance, in order to verify the driving performance of an autonomous vehicle, vehicle control is verified by creating a virtual scenario, inputting virtual signals, and collecting data of corresponding driving operation. However, in this case, it is difficult to simulate conditions depending on weather changes such as snow, rain, and fog, it is difficult to evaluate driving control operation on an actual road because of data that is not collected on an actual environment, and there is a problem in that creating the virtual scenario is costly and time consuming.

In the present disclosure, since driving performance is evaluated by using sensing data obtained while an autonomous vehicle is driving on an actual road, and the sensing data directly obtained from the autonomous vehicle is used, there is an advantage that more accurate evaluation is realizable.

Each of the first driving data and the second driving data is generated and stored in the electronic control unit (ECU) and provided to the verification control unit 140.

Each of the first driving data and the second driving data may include speed information, steer information, pedal information, and the like of the autonomous vehicle, thereby including information on the operation status of each part required for the driving of the autonomous vehicle. In particular, the first and second driving data may include information on driving speed, brake operation status, accelerator pedal operation status, a steering wheel operation amount, etc.

In the verification control unit 140, the verification of driving performance of the autonomous vehicle, the verification being performed by comparing the first driving data and the second driving data, is realizable by comparing the movements of the autonomous vehicle, that is, by comparing differences in mechanical operation, steering angles, etc., in the same sensor environment. In addition, it is possible to compare differences in the response speed for the same sensing data, steering, acceleration, and deceleration, and to compare differences in at what point and to what extent the driving devices such as steering wheels, accelerators, brakes, etc., are operated. Through this way, it is possible to determine whether or not there is a problem with sensing data recognition of the autonomous vehicle, whether or not there is a problem with software, or whether or not there is a problem with hardware (i.e., mechanical devices).

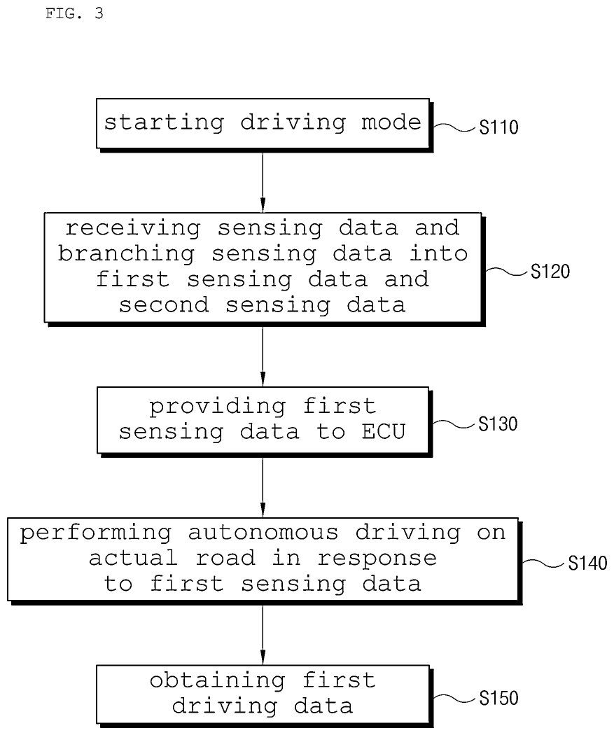

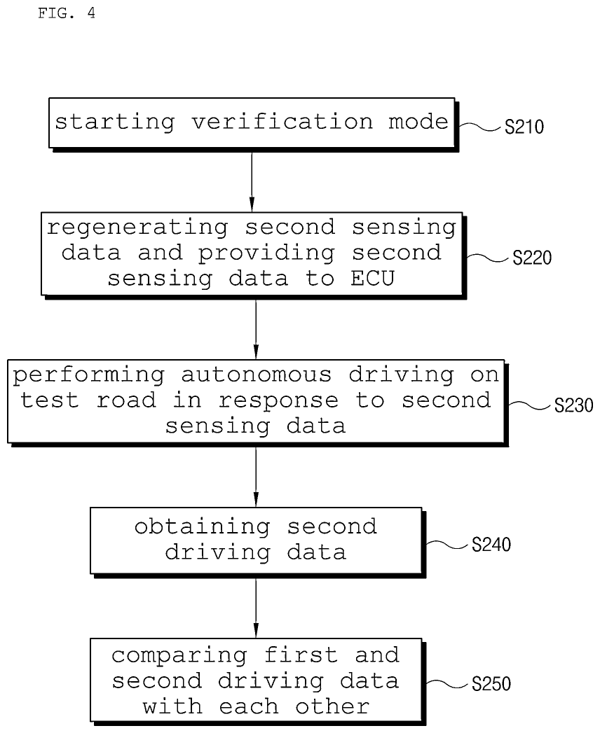

Hereinafter, a driving performance verification method using a driving performance verification device 100 of an autonomous vehicle will be described with reference to FIGS. 3 and 4.

FIG. 3 is a flowchart illustrating operation in a driving mode. FIG. 4 is a flowchart illustrating operation in a verification mode.

Before starting a driving mode and a verification mode, a driving performance verification device 100 described above is mounted on an autonomous vehicle. The driving performance verification device 100 is mounted in between an electronic control unit (ECU) and a sensor 10, which are mounted on the autonomous vehicle, and is configured such that sensing data sensed by the sensor 10 is not directly transmitted to the electronic control unit (ECU), but is transmitted to the electronic control unit (ECU) through the driving performance verification device 100 and, more specifically, through a reception unit 110 and a branch unit 120.

As shown in FIG. 3, when the driving mode to be performed on an actual road starts in step S110, the reception unit 110 receives, in step S120, the sensing data sensed and received in real time from each sensor mounted on the autonomous vehicle while the autonomous vehicle as a verification target is driving on the actual road and the branch unit 120 branches the sensing data into first sensing data and second sensing data, which are identical to each other.

Thereafter, the first sensing data is provided from the branch unit 120 to the electronic control unit (ECU) of the autonomous vehicle in step S130, the electronic control unit (ECU) controls the driving of the autonomous vehicle on the actual road in response to the first sensing data in step S140, and at this time, the second sensing data is stored in a regeneration unit 130.

In step S150, the first driving data recorded through the autonomous driving in the driving mode is transmitted to, obtained by, and stored in a verification control unit 140.

Thereafter, as shown in FIG. 4, the verification mode starts in step S210. The verification mode is performed on a separately set test road, not on the actual road.

In the verification mode, the process is performed in a way of providing, to the electronic control unit (ECU) in step S220, the second sensing data stored in the regeneration unit 130 in the driving mode, rather than the sensing data sensed in real time by each sensor 10 mounted on the autonomous vehicle.

Thereafter, in step S230, the electronic control unit (ECU) controls the autonomous driving of the autonomous vehicle on the test road in response to the second sensing data.

In this case, in step S240, the second driving data recorded through the autonomous driving in the verification mode is transmitted to, obtained by, and stored in a verification control unit 140.

Thereafter, in step S250, the driving performance of the autonomous vehicle is verified through match or not by comparing the first driving data recording the driving situation in the driving mode with the second driving data recording the driving situation in the verification mode.

The verification of the driving performance of the autonomous vehicle is realizable by comparing the movements of the autonomous vehicle, that is, by comparing differences in mechanical operations, steering angles, etc., in the same sensor environment. In addition, it is possible to compare differences in the response speed for the same sensing data, steering, acceleration, and deceleration, and to compare differences in at what point and to what extent the driving devices such as steering wheels, accelerators, brakes, etc., are operated. Through this way, it is possible to determine whether or not there is a problem with sensing data recognition of the autonomous vehicle, whether or not there is a problem with software, or whether or not there is a problem with hardware (i.e., mechanical devices).

As described above, according to the present disclosure, driving performance of an autonomous vehicle may be accurately and effectively verified by performing actual vehicle simulation on the basis of sensing data sensed on an actual road.

The description of the above-described exemplary embodiment is merely an example with reference to the drawings for a more thorough understanding of the present disclosure, and should not be construed as limiting the present disclosure. In addition, it will be clear to those skilled in the art that various changes and modifications may be made without departing from the fundamental principle of the present disclosure.

What is claimed is:

1. A driving performance verification device for an autonomous vehicle, the device comprising:
a reception unit configured to operate in a driving mode and receive in real time sensing data sensed and provided in real time from each of sensors mounted on the autonomous vehicle while driving is conducted on an actual road;
a branch unit configured to operate in the driving mode, and branch and provide the sensing data into first sensing data and second sensing data, which are identical to each other;
a sensing data regeneration unit configured to store in real time the second sensing data provided from the branch unit in the driving mode and regenerate the stored second sensing data in a verification mode; and
a verification control unit configured to allow, in the driving mode performed on the actual road, the first sensing data provided in real time to be provided to an electronic control unit (ECU) of the autonomous vehicle and obtain first driving data by allowing the electronic control unit (ECU) to perform autonomous driving on the actual road in response to the first sensing data, and configured to control, in the verification mode performed on a separately set test road, the second sensing data regenerated through the sensing data regeneration unit to be provided to the electronic control unit (ECU), obtain second driving data by allowing the electronic control unit (ECU) to perform the autonomous driving on the test road in response to the second sensing data, and verify driving performance through match or not by comparing the first driving data recording a driving situation in the driving mode with the second driving data recording a driving situation in the verification mode.

2. The device of claim 1, wherein, in the verification mode, the reception unit and the branch unit does not operate.

3. The device of claim 1, wherein the sensors comprise at least one of a camera, a lidar, a radar, an ultrasonic sensor, a steering sensor, a temperature/humidity sensor, and a GPS.

4. The device of claim 1, wherein the electronic control unit (ECU) is provided with a learned AI autonomous driving algorithm built therein and performs the autonomous driving in response to the first sensing data or the second sensing data.

5. A driving performance verification method for an autonomous vehicle, the method comprising:
a first step of starting a driving mode performed on an actual road and branching sensing data sensed and received in real time from each of sensors mounted on the autonomous vehicle while driving is conducted on the actual road into first sensing data and second sensing data, which are identical to each other;
a second step of allowing the first sensing data to be provided to an electronic control unit (ECU) of the autonomous vehicle and storing the second sensing data;
a third step of obtaining first driving data by allowing the electronic control unit (ECU) to perform autonomous driving on the actual road in response to the first sensing data;
a fourth step of starting a verification mode performed on a separately set test road and regenerating the second sensing data so as to allow the second sensing data to be provided to the electronic control unit (ECU);
a fifth step of obtaining second driving data by allowing the electronic control unit (ECU) to perform the autonomous driving on the test road in response to the second sensing data; and
a sixth step of performing verification on driving performance through match or not by comparing the first driving data recording a driving situation in the driving mode with the second driving data recording a driving situation in the verification mode.

6. The method of claim 5, wherein the sensors comprise at least one of a camera, a lidar, a radar, an ultrasonic sensor, a steering sensor, a temperature/humidity sensor, and a GPS.

7. The method of claim 5, wherein each of the first driving data and the second driving data comprises information on operation status of each part required for the driving of the autonomous vehicle.
